(19) United States
(12) Patent Application Publication
(10) Pub. No.: US 2025/0167270 A1
(43) Pub. Date: May 22, 2025

(54) METHOD FOR CONTROLLING A FUEL CELL AT VERY LOW PARTIAL PRESSURES UP TO NULL

(71) Applicant: Robert Bosch GmbH, Stuttgart (DE)

(72) Inventor: Antonius Bader, Holzgerlingen (DE)

(21) Appl. No.: 18/840,236

(22) PCT Filed: Feb. 21, 2023
(86) PCT No.: PCT/EP2023/054262

§ 371 Date: Aug. 21, 2024

(30) Foreign Application Priority Data
Mar. 3, 2022 (DE) 10 2022 202 160.6

(51) Int. Cl. H01M 8/04302; H01M 8/04225; H01M 8/0438; H01M 8/04858; H01M 8/04955; H01M 8/04992

(52) U.S. Cl. CPC H01M 8/04302; H01M 8/04225; H01M 8/04388; H01M 8/04395; H01M 8/04873; H01M 8/04902; H01M 8/04932; H01M 8/04955; H01M 8/04992

(57) ABSTRACT

The invention relates to a method (1000) for controlling a fuel cell (1) comprising an anode (11) and a cathode (12),
wherein the method has at least the following steps:
   receiving (100) one pressure value (pᵢ) for each gas component (2a, 2b, 2c, 2d) relevant during the operation of the fuel cell and present in the anode chamber (110) or in the cathode chamber (120),
   specifying (200) a current (I) for actuating the fuel cell (1),
   calculating (300) a target voltage (Us) based on the specified current (I) using the received pressure values (pᵢ), wherein the calculation is based on a numerical conversion of a specified relationship which converts the target voltage (Us) into the specified current (I), and the numerical conversion is based on addition, subtraction, multiplication, division, exponentiation, but is free of numerical logarithm calculations,
   actuating (400) the fuel cell (1) at the specified current (I),
   measuring (500) the resulting voltage (U) at the fuel cell (1), and
   comparing (600) the measured voltage (U) with the calculated target voltage (Us).

### BACKGROUND

The present invention relates to a method for controlling a fuel cell. The invention also relates to a computer program implementing the method specified hereinabove, a machine-readable data carrier having such a computer program, and one or a plurality of computers comprising the computer program specified hereinabove.

Control and calculation methods for the operation of fuel cells are based on positive absolute (partial) pressures of the gases in the fuel cells. In mobile automotive fuel cells, this conventionally involves a hydrogen pressure in the anode and an oxygen pressure in the cathode. In regulation methods, the source open-circuit voltage is typically calculated using the Nernst equation. The latter contains expressions in which the partial pressure of a gas component in the fuel cell appears as an argument of a logarithm.

### SUMMARY

During initial starting operations when the gas chambers are not yet filled with the operating gases of the fuel cell, and during stopping operations when the operating gases are released, partial pressures of the operating gases up to and including null pressure may occur. When shutting down a fuel cell stack, the anode and/or cathode chamber can be closed via valves so that no further gas flows in or out. The remaining quantity of gas in the anode and/or cathode can thereafter be completely consumed by drawing current from the fuel cell stack. The corresponding partial pressures may fall to values very close to and including zero.

It has been recognized that a control or regulation of a fuel cell by means of currently common methods may have difficulties in those cases in which little or no gas is supplied to at least one electrode. If the partial pressure drops close or to zero, then calculation of the source open-circuit voltage using the Nernst equation will fail, so the controller will no longer receive any information about the current operating state of the fuel cell. This may be the case for starting or stopping operations as described hereinabove. Similarly, after a prolonged service life, the fuel (e.g., hydrogen) and/or the oxidizing agent (e.g., oxygen) may have fully reacted so that only nitrogen remains in the anode and/or cathode. Furthermore, in many cases the fact that not only one gas is generally present in the anode or cathode chamber due to diffusion processes is, among other things, currently not or not sufficiently taken into account.

The method according to the invention relates to controlling a fuel cell comprising an anode and a cathode, said method having at least the steps described hereinafter.

A pressure value is received for each of the gas components relevant during the operation of the fuel cell, which may be present in the anode chamber or the cathode chamber. This pressure value can, e.g., come from a sensor, but also, e.g., from a model calculation.

A current for actuating the fuel cell is also provided. Using the received pressure values, a target voltage is subsequently determined based on the specified current. Used in this case is a known relationship between the specified current or the corresponding current density and the target voltage, which takes into account all relevant pressure values (Butler-Volmer equation taking into account mixing potentials). The relationship expresses the current as a function of the target voltage and the pressure values of all relevant gas components, and it is numerically converted as part of the method. An analytical conversion function does not exist for the general case. In the context of the numerical conversion, the calculation is based on addition, subtraction, multiplication, division, and exponentiation, but is free of numerical logarithm calculations. In a further method step, the fuel cell is actuated at the specified current, and the resulting voltage at the fuel cell is measured. The measured voltage value is further compared with the calculated target voltage.

The gas components relevant during the operation of the fuel cell can at least include the fuel supplied at the anode and the oxidizing agent supplied at the cathode. For example, due to diffusion processes through the electrolyte used in the fuel cell, a non-negligible amount of fuel may also be present in the cathode chamber and, conversely, a non-negligible amount of oxidizing agent may also be present in the anode chamber. The reaction product, e.g. water, also plays a role. Furthermore, as part of the chemical processes taking place inside the fuel cell, further gas components can be formed that may enter the electrode chambers due to diffusion. All of the gas components which are in principle present and non-negligible should be taken into account when calculating the target voltage or other relevant variables of the fuel cell.

The calculation of expressions containing logarithms causes numerical difficulties in cases where the argument of the logarithm is very small, and the logarithm thus assumes very large (negative) expressions. A calculation which takes into account logarithms having small arguments may in particular become numerically unstable. Numerical inaccuracies may develop into major errors. The latter is also relevant in the cases where calculations for controlling fuel cells have been developed and tested on a specific computer type and are then, e.g., loaded onto a control device in a motor vehicle. Such control devices are generally less powerful in terms of computational capacities and utilize their own libraries and logarithm tables, so the software may behave differently there than on the computers on which it was developed. The software could also behave differently if it is implemented on a new control device having a different chipset performing the numerical calculations of the logarithm using a different algorithm. It is therefore helpful and advantageous to avoid the sources of error specified hereinabove and associated with the calculation of logarithms, and to provide a more robust calculation that is less affected by numerical problems. This is provided by the invention described herein.

The method can be free of numerical logarithm calculations, because it is based on a form of the Butler-Volmer equation with mixing potentials obtained by transformations, in which terms of the form ln(pᵢ/pᵢ₀) do not occur. In the above expression, pᵢ denotes the partial pressure of the i-th gas component, and pᵢ₀ denotes a (positive fixed) reference pressure of the i-th gas component. Instead of being a logarithmic argument, the ratio pᵢ/pᵢ₀ appears in this method as a base in the following expression: (pᵢ/pᵢ₀)^{αi±a}^{ᵢ}^{/n}^{ᵢ}. The exponent is determined by the chemical and physical properties of the i-th gas component and is always greater than 0 given the chemical substances typically used. For example, regarding a reaction of oxygen to water in the cathode, the (effective) reaction order γ can be selected in the range from 0.5 . . . 1, and the transfer coefficient α can be selected in the range from 0.9 . . . 1.5. The number of electrons involved in the reaction is n=4. In the cathode, γ+α/n must be selected and, in the worst case, 0.5+0.9/4=0.725 is the result.

A problem such as very large logarithms having small argument values does not then occur. The case of pᵢ=0 is also unproblematic because there is no division by pᵢ.

Very small values for the partial pressure of an operating gas component relevant to the operation of the fuel cell are real. These can occur if, for example, there is no (or no longer a) gas supply when the anode and/or cathode chamber is closed, but current continues to flow via a resistor, as can occur during stopping operations, among other things. Gas components still present in the respective electrode chamber may continue to be consumed as part of the chemical reactions within the fuel cell, so their pressure contribution becomes very small. Another, similar case may occur if water produced during operation of the fuel cell freezes.

According to one exemplary embodiment, the actuation of the fuel cell is changed such that a deviation between the determined target voltage and the voltage measured at the fuel cell is reduced. The method can thus be used for fault diagnosis and/or compensation if a malfunction of the fuel cell is recognized.

According to one exemplary embodiment, a malfunction and/or a degradation of the fuel cell is derived and evaluated, in particular based on the deviation between the target voltage and the measured voltage.

The method can thus help to ensure faultless operation of the fuel cell in a motor vehicle and to prolong the possible service life of the fuel cell.

According to one exemplary embodiment, the specified current in the relationship specified hereinabove is selected such that the fuel cell is operated at a working point in which degradation of the fuel cell is reduced.

The service life of the fuel cell can be extended, thus saving corresponding manufacturing and supply costs for the fuel cell.

According to one exemplary embodiment, the actuation of the fuel cell is changed such that, at the same specified current, the power output by the fuel cell remains constant regardless of the degradation.

According to a further exemplary embodiment, the fuel cell is actuated at the specified current in an operating mode in which no fuel is supplied to the anode and/or no oxidizing agent is supplied to the cathode, and the pressure of at least one gas component reduces sharply at at least one of the two electrodes.

This situation may exist, for example, during stopping operations in which there may no longer be a gas supply when the anode or cathode chamber is closed, but current is being dissipated via a resistor. In this case, the gas still present in the corresponding electrode chamber is further consumed or converted as part of the chemical reactions taking place in the fuel cell, so the partial pressure of the gas component under consideration reduces further. The method for controlling a fuel cell described herein also provides robust values for the target voltage in the situation specified hereinabove, which can ultimately be used to control of the fuel cell. This is achieved as a result of the method being free of logarithms, the argument of which can be a very small (partial) pressure value.

According to one exemplary embodiment, the fuel used in the fuel cell can be hydrogen, and the oxidizing agent used in the fuel cell can be oxygen or air.

For example, the method described herein can find application in the control of PEM fuel cells.

According to one exemplary embodiment, a mixture of multiple gases can be present at both the anode and cathode sides.

For example, the anode-side gas mixture and the cathode-side gas mixture can each consist of at least the fuel supplied to the fuel cell at the anode side and the oxidizing agent supplied to the fuel cell at the cathode side.

In many cases, a diffusion of fuel or oxidizing agent through the electrolyte to the other electrode should be prevented. However, if diffusion processes occur through the electrolyte, a gas mixture comprising both fuel and oxidizing agent may be present in at least one of the two electrode chambers of the fuel cell. This case is taken into account in the method described herein.

It is also possible—and can be taken into account in the method described herein—that the cathode-side and/or the anode-side gas mixture contains at least one further component which is, e.g., formed as part of those chemical reactions taking place within the fuel cell. For example, a hydrogen-containing fuel gas obtained by reformation of a hydrocarbon-containing fuel (e.g., methanol or natural gas) may also contain byproducts or impurities from the reformation.

According to one exemplary embodiment, the fuel cell considered as part of the method described herein can be part of a fuel cell stack.

Typically, the fuel cells of a fuel cell stack are connected in series and can be used to generate current in a fuel cell vehicle. The method described herein can be used to reliably and stably control situations in which gas is not (or is no longer) being supplied to at least one of the electrodes of at least one fuel cell of the stack, and gas continues to be converted in the electrode chamber by drawing current via a resistor. Numerical problems in the context of computer-aided control or regulation of the fuel cells due to very low (partial) pressures are avoided in the method presented herein.

The invention further relates to a computer program comprising machine-readable instructions which, when executed on one or a plurality of computers, prompt the computer or computers to perform a method according to the invention. The invention also comprises a machine-readable data carrier on which the aforementioned computer program is stored, as well as a computer equipped with the computer program specified hereinabove or the machine-readable data carriers specified hereinabove.

### BRIEF DESCRIPTION OF THE DRAWINGS

Further measures for improving the invention are described in greater detail hereinafter, together with the description of the preferred exemplary embodiments of the invention, with reference to the drawings.

Shown are:

FIG. 1 an exemplary embodiment of the method for controlling a fuel cell;

FIG. 2 a further exemplary embodiment.

### DETAILED DESCRIPTION

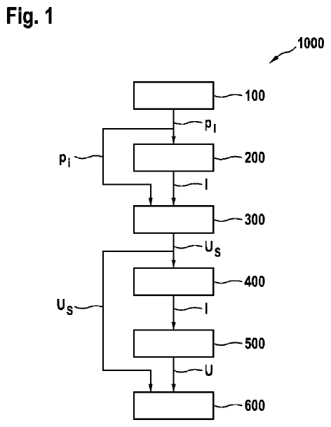

FIG. 1 shows one embodiment of a method 1000 for controlling a fuel cell 1, consisting of the steps specified hereinafter.

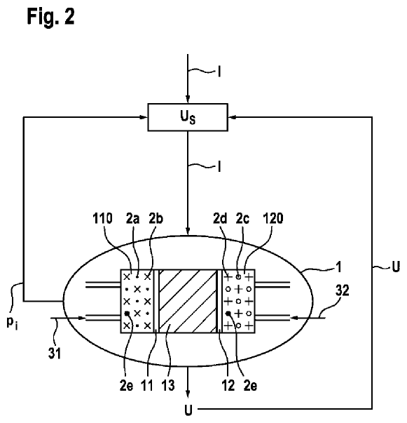

In step 100, a pressure value pᵢ is received which corresponds to the i-th gas component relevant during the operation of the fuel cell 1, which component may be present in the anode chamber or cathode chamber of the fuel cell. (In FIG. 2, corresponding gas components are designated as 2a, 2b, 2c, 2d, and 2e.)

In step 200, a current I is specified for actuating the fuel cell 1, based on which a target voltage Us at the fuel cell is calculated in step 300 using the received pressure values pᵢ. The corresponding calculation is based on the numerical conversion of a relationship that expresses the specified current I by the target voltage Us (generalized Butler-Volmer equation including mixing potential calculation).

The computational operations of addition, subtraction, multiplication, division and exponentiation are used as part of the numerical conversion. However, the procedure does not calculate numerical logarithms. The method presented is intended in particular to cover the cases in which at least one of the (partial) pressures in the anode and/or cathode chamber of the fuel cell 1 is very low or diminishing. In the expression of the Butler-Volmer equation usually used as a basis, logarithms occur whose argument contains the partial pressure, ln(pᵢ/pᵢ₀), where pᵢ₀ denotes a reference pressure for the i-th gas component.

At low or even diminishing pressure contributions by the corresponding component, this form thus poses a problem. The method presented herein uses a modified form of the corresponding equations obtained by term transformations in which the partial pressures pᵢ no longer appear as an argument of the logarithm. The numerical conversion based on the modified form enables a numerically stable consideration and observation, in particular given very low partial pressures. Such situations can occur as previously described hereinabove, e.g. during stopping operations of a fuel cell-powered motor vehicle.

In step 400, the fuel cell 1 is actuated at the specified current I and, in step 500, the resulting voltage U at the fuel cell 1 is then measured.

Finally, in step 600, the resulting voltage U is compared with the previously calculated target voltage Us.

The comparison can, e.g., be used to diagnose degradation or a malfunction of the fuel cell. In response to an established degradation, the fuel cell can be actuated such that, for example, the effects of a degradation can be minimized, and a maximum power can still be obtained from the fuel cell. However, it can also be provided that the fuel cell is actuated at a current in response to a diagnosed degradation or malfunction such that the deviation between the target voltage and the measured voltage is at least reduced. Alternatively or additionally, the fuel cell can then be operated at a working point at which further degradation is reduced. However, the fuel cell can also be actuated such that its output power remains constant regardless of the degradation.

FIG. 2 shows a fuel cell 1 comprising an anode 11 and a cathode 12, which are each arranged in an anode chamber 110 and cathode chamber 120 and adjoin an ion-conducting electrolyte 13. The fuel cell 1 can be supplied with fuel 31 at the anode side, and an oxidizing agent 32 can be supplied at the cathode side. The fuel 31 can, e.g., be hydrogen, and the oxidizing agent 32 can be oxygen or air. The respective gas components 2a, 2b, 2c, 2d, 2e are present in the anode chamber 110 or cathode chamber 120 and participate in the chemical reactions taking place within the fuel cell 1. The five gas components 2a-2e are specifically mentioned in this case merely by way of example, and this should not be understood as limiting. In principle, the method functions for any desired number of gas components, whereby the computational effort at the partial pressures pᵢ of the gas components are measured and used for the numerical calculation of the target voltage Us. As part of the calculation, a current I is also specified, by way of which the fuel cell 1 is intended to be subsequently actuated. A numerical calculation of the target voltage Us is first performed using the partial pressures pᵢ and the specified current I, as previously described hereinabove. After determining the target voltage Us, the fuel cell 1 is actuated at the specified current I, and the resulting voltage U at the fuel cell is measured. A comparison between the resulting voltage and the determined target voltage Us can then be used for diagnostic purposes, e.g. the determination of a malfunction or a degradation of the fuel cell 1. As a result, a new target voltage Us can be recalculated at a changed specified current I, with the aim of, e.g., compensating for the degradation of the fuel cell. If the fuel cell 1 is then actuated at the changed specified current I, then a drop in performance of the fuel cell 1 due to its degradation can, e.g., be reduced.

1. A method (1000) for controlling a fuel cell (1) comprising an anode (11) and a cathode (12), wherein the method has at least the following steps:
receiving (100), at a computer, one pressure value (Pᵢ) for each gas component (2a, 2b, 2c, 2d) relevant during the operation of the fuel cell and present in the anode chamber (110) and the cathode chamber (120),
specifying (200), via the computer, a current (I) for actuating the fuel cell (1),
calculating (300), via the computer, a target voltage (Us) based on the specified current (I) using the received pressure values (pᵢ), wherein the calculation is based on a numerical conversion of a specified relationship which converts the target voltage (Us) into the specified current (I), and the numerical conversion is based on addition, subtraction, multiplication, division, and exponentiation, but is free of numerical logarithm calculations,
actuating (400), via the computer, the fuel cell (1) at the specified current (I),
measuring (500) the resulting voltage (U) at the fuel cell (1), and
comparing (600), via the computer, the measured voltage (U) with the calculated target voltage (Us).

2. The method (1000) according to claim 1, wherein the actuation of the fuel cell (1) is changed, with the aim of reducing a deviation between the target voltage (Us) and the measured voltage (U).

3. The method (1000) according to claim 1, wherein, based on a deviation between the target voltage (Us) and the measured voltage (U), a malfunction and/or degradation of the fuel cell (1) is evaluated.

4. The method (1000) according to claim 1, wherein the specified current (I) is selected such that the fuel cell (1) is operated at a working point at which degradation of the fuel cell (1) is reduced.

5. The method (1000) according to claim 1, wherein the actuation of the fuel cell (1) is changed such that, at the same specified current (I), the power output from the fuel cell (1) remains constant regardless of the degradation.

6. The method (1000) according to claim 1, wherein the fuel cell (1) is actuated at the specified current (I) during an operation mode in which no fuel (31) is supplied at the anode (11) and/or no oxidizing agent (32) is supplied at the cathode (12), and the pressure (pᵢ) of at least one gas component (2a, 2b, 2c, 2d) at at least one of the two electrodes (11,12) sharply decreases.

7. The method (1000) according to claim 1, wherein the fuel (31) used in the fuel cell (1) is hydrogen, and the oxidizing agent (32) used in the fuel cell (1) is oxygen or air.

8. The method (1000) according to claim 1, wherein a gas mixture comprising multiple gas components (2a, 2b; 2c, 2d) is present at both the cathode side and the anode side.

9. The method (1000) according to claim 8, wherein the anode-side gas mixture (2a, 2b) and the cathode-side gas mixture (2c, 2d) consist at least of the fuel (31) supplied to the fuel cell (1) at the anode side and the oxidizing agent (32) supplied to the fuel cell (1) at the cathode side.

10. The method (1000) according to claim 8, wherein the cathode-side gas mixture (2c, 2d) and/or the anode-side gas mixture (2a, 2b) further contains a component (2e) which is formed as part of the chemical reactions taking place within the fuel cell (1).

11. The method (1000) according to claim 1, wherein the fuel cell (1) is part of a fuel cell stack.

12. A non-transitory, computer-readable medium containing instructions which, when executed on one or a plurality of computers, prompt the computer or computers to perform a method (1000) according to claim 1.

13. (canceled)

14. A computer programmed to
obtain (100) a pressure value (Pᵢ) for each gas component (2a, 2b, 2c, 2d) relevant during the operation of the fuel cell and present in the anode chamber (110) and the cathode chamber (120),
specify (200) a current (I) for actuating the fuel cell (1),
calculate (300) a target voltage (Us) based on the specified current (I) using the received pressure values (pᵢ), wherein the calculation is based on a numerical conversion of a specified relationship which converts the target voltage (Us) into the specified current (I), and the numerical conversion is based on addition, subtraction, multiplication, division, and exponentiation, but is free of numerical logarithm calculations,
actuate (400) the fuel cell (1) at the specified current (I),
determine (500) the resulting voltage (U) at the fuel cell (1), and
compare (600), the determined voltage (U) with the calculated target voltage (Us).
